(19) United States
(12) Patent Application Publication
(10) Pub. No.: US 2013/0168396 A1
(43) Pub. Date: Jul. 4, 2013

(54) TRASH CAN WITH BAG COLLAR

(71) Applicant: David Quan, Toronto (CA)

(72) Inventor: David Quan, Toronto (CA)

(73) Assignee: UMBRA LLC, Buffalo, NY (US)

(21) Appl. No.: 13/340,233

(22) Filed: Dec. 29, 2011

(51) Int. Cl. B65F 1/06; B65D 25/16; B65D 25/20

(52) U.S. Cl. 220/495.11; 220/495.08

(57) ABSTRACT

A container assembly is presented that includes a container and a collar supported by the container. The container possesses a bottom surface, at least one wall with at least one top edge extending from the bottom surface. The collar includes at least one inner wall and at least one outer wall, with at least one curved edge joining the at least one outer wall and the at least one inner wall. The inner and outer walls form a channel. In one embodiment, a flexible liner is held in place by the collar.

### FIELD OF THE INVENTION

The field of the present invention is trash containers, more particularly trash containers that include flexible liners, and more particularly trash containers that include devices to hold flexible liners in place.

### BACKGROUND OF THE INVENTION

Trash cans or containers are used to contain trash or garbage of all types of materials, from clean trash such as, for example, paper products and plastic or metal articles to grimy or soiled trash such as, for example, dirty cloths or paper towels, food products, and drink containers. One way to maintain trash containers in a sanitary condition is to line them with a flexible container liner such as a plastic bag, that can be removed when full, thus removing both clean and soiled trash and leaving the container itself in a clean condition.

One problem with using flexible liners is that they tend to collapse into the container thereby losing their lining capacity. Typical bag holders include straps, rubber bands, and twist ties that can be used to hold the bags in place but each of them requires the bag to be draped over the edge of the container which can be aesthetically unappealing.

What is needed then is a device to hold a flexible liner in place while hiding the unattractive look of a draped flexible bag hanging over the top edge of a container.

### SUMMARY OF THE INVENTION

The present invention broadly comprises a container assembly comprising a container that includes a bottom surface, at least one wall extending from the bottom surface, and the at least one wall having a top edge. The assembly also includes a collar including at least one inner wall; at least one outer wall; and at least one curved edge joining the at least one outer wall with the at least one inner wall such that the at least one inner wall and the at least one outer wall form a channel therebetween. In a preferred embodiment, the container assembly further comprises a flexible liner. In a second preferred embodiment, the collar fits over the at least one top edge in a snug fit.

In one embodiment, the container assembly includes a trash container and collar each with one wall. In an alternate embodiment, the container assembly includes a trash container and collar each with more than one wall.

One object of the invention is to provide a container assembly in which a flexible liner is held in place to prevent it from collapsing into the container.

A second object of the invention is to supply a bag holder that is easily removable.

A third object of the invention is to present a flexible bag holder that is aesthetically appealing.

### BRIEF DESCRIPTION OF THE SEVERAL VIEWS OF THE DRAWINGS

The nature and mode of the operation of the present invention will now be more fully described in the following detailed description of the invention taken with the accompanying drawing Figures, in which:

FIG. 1 is a top perspective view of the trash can assembly of the present invention;

FIG. 2 is a top perspective view of the collar showing the inner surface and outer surface of the outer wall of the collar;

FIG. 3 is a cross section of the assembly with the collar fit over the top edge of the container;

FIG. 4 is an exploded top perspective view of the collar and container of the trash can assembly;

FIG. 5 is an exploded top perspective view of the trash can assembly demonstrating the functional relationship between the components of the assembly and a flexible inner liner placed inside the container;

FIG. 6 is a top perspective view of a flexible liner placed within the container with the upper portion draped over the top edge of the container;

FIG. 7 is an enlarged view of circled area 7 in FIG. 3;

FIG. 8 shows assembly 10 with collar 20 snug fit over top edge 15;

FIG. 9 demonstrates the snug fit holding a flexible liner between the inner wall of the collar and the inner surface of the container;

FIG. 10 is a top perspective view of a second embodiment of the trash can assembly in which the container and collar each include a plurality of walls; and,

FIG. 11 is an exploded view similar to FIG. 4 showing how a second embodiment of the collar fits over and is supported by the top edges of a second embodiment of the container.

### DETAILED DESCRIPTION OF EMBODIMENTS OF THE INVENTION

At the outset, it should be appreciated that like drawing numbers on different drawing views identify identical structural elements of the invention. It also should be appreciated that figure proportions and angles are not always to scale in order to clearly portray the attributes of the present invention.

While the present invention is described with respect to what is presently considered to be the preferred embodiments, it is understood that the invention is not limited to the disclosed embodiments. The present invention is intended to cover various modifications and equivalent arrangements included within the spirit and scope of the appended claims.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. It should be appreciated that the term “substantially” is synonymous with terms such as “nearly”, “very nearly”, “about”, “approximately”, “around”, “bordering on”, “close to”, “essentially”, “in the neighborhood of”, “in the vicinity of”, etc., and such terms may be used interchangeably as appearing in the specification and claims. Although any methods, devices or materials similar or equivalent to those described herein can be used in the practice or testing of the invention, the preferred methods, devices, and materials are now described. It should be appreciated that the term “proximate” is synonymous with terms such as “nearby”, “close”, “adjacent”, “neighboring”, “immediate”, “adjoining”, etc., and such terms may be used interchangeably as appearing in the specification and claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

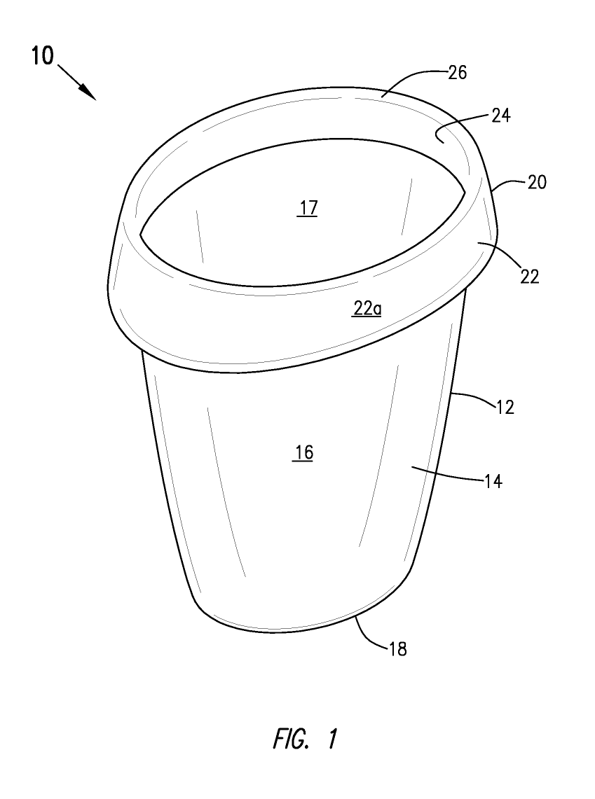

Adverting to the drawings, FIG. 1 is a top perspective view of trash can assembly 10 (“assembly 10”). Container 12 includes at least one container wall 14 (“wall 14”) with outer surface 16 and inner surface 17. Wall 14 extends from bottom surface 18. Persons of skill in the art will recognize that while FIG. 1 shows a container with one wall, other containers with a plurality of walls, such as seen in FIGS. 10 and 11 may be used as described below. Not seen in FIG. 1 is top edge 15 of container 12.

Collar 20 is seen supported by container 12. Collar 20 includes outer collar wall 22 (“outer wall 22”) with outer surface 22a and inner collar wall 24 (“inner wall 24”). Outer wall 22 and inner wall 24 are joined by at least one curved edge 26. FIG. 2 is a top perspective view of collar 20 showing inner surface 22b of outer wall 22.

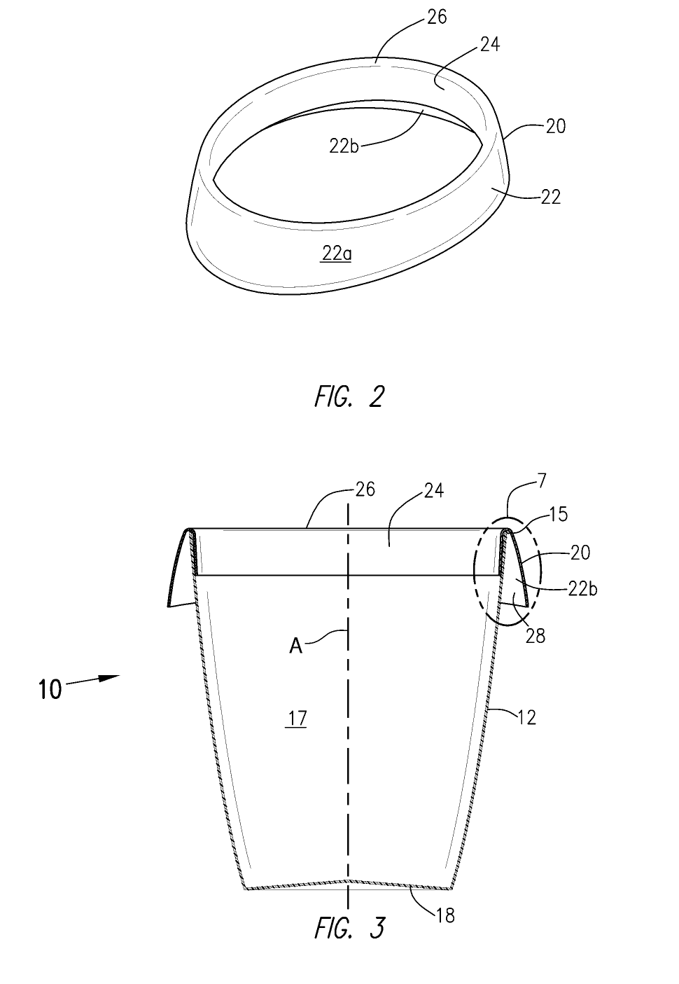

FIG. 3 is a cross section of assembly 10 with collar 20 supported and fit over top edge 15 of container 12. FIG. 3 depicts channel 28 formed between outer wall 22 and inner wall 24. FIG. 3 demonstrates the close or snug fit between the outer surface of inner wall 24 and inner surface 17 of container 12. Preferably, inner wall 24 and inner surface 17 fit sufficiently snug to hold collar 20 onto container 12, but is still easily removed when a user lifts collar 20 off top edge 15. FIG. 4 is an exploded top perspective view of collar 20 over container 12 showing collar 20 in position to be placed on top edge 15 of container 12. FIG. 7 is an enlarged view of circled area 7 in FIG. 3. FIG. 7 shows the contact between inner wall 24 and inner surface 17 to form the snug fit.

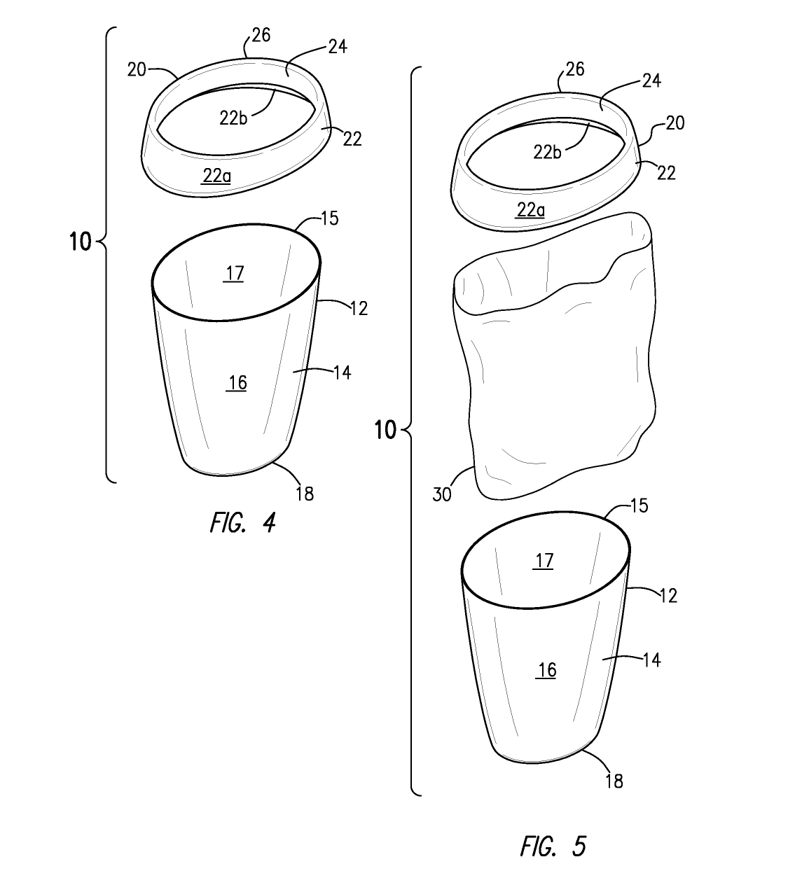

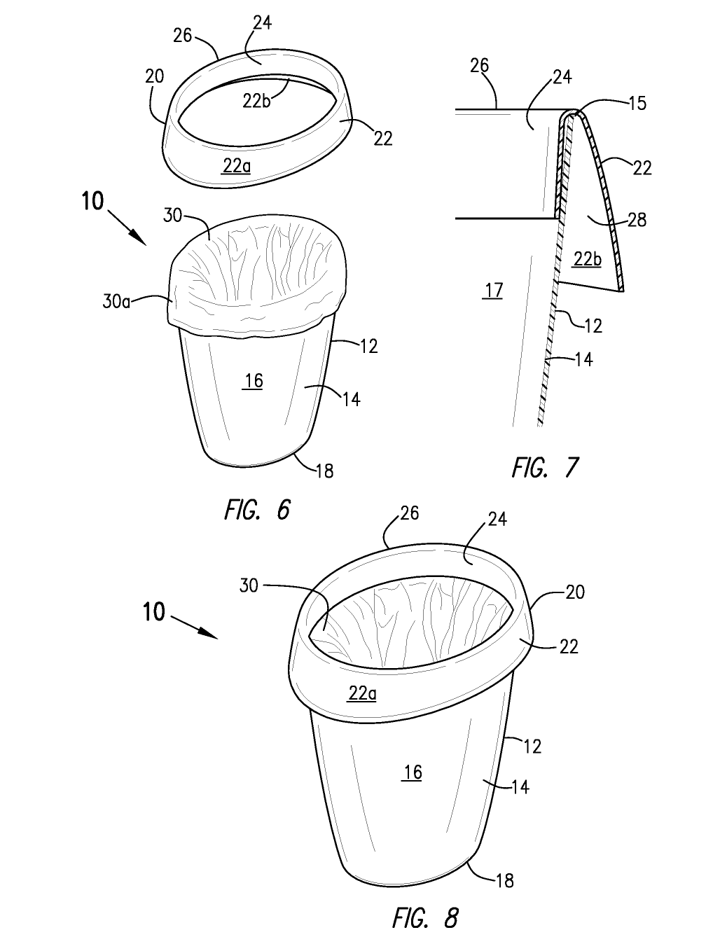

FIG. 5 is an exploded top perspective view of assembly 10 similar to FIG. 4 showing the functional relationship between the components of assembly 10 and flexible inner liner 30 to be placed inside container 12. FIG. 6 is a top perspective view showing liner 30 placed within container 12 with upper portion 30a draped over top edge 15. FIG. 8 shows assembly 10 with collar 20 fit over top edge 15. As seen in FIG. 8, preferably, upper portion 30a does not extend below outer wall 22 of collar 20. Liner 30 may be made from any flexible material such as cloth or suitable plastics know in the art and may be disposable or reusable.

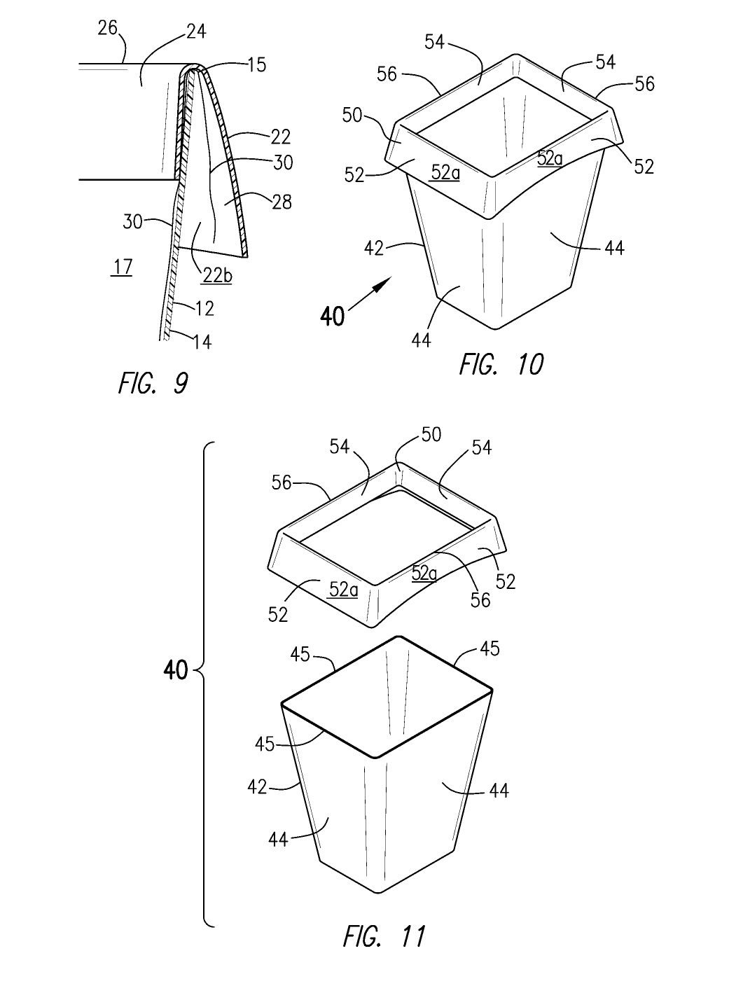

FIG. 9 depicts the same view as FIG. 7 demonstrating the snug fit holding liner 30 between inner wall 24 and inner surface 17. Upper portion 30a drapes over top edge 15 into channel 28. FIG. 9 shows a preferred embodiment which outer wall 22 extends below upper portion 30a.

FIG. 10 depicts trash can assembly 40 in which container 42 and collar 50 each include a plurality of walls. Container 42 includes walls 44 and top edges 45 (seen in FIG. 11), while collar 50 possesses a plurality of walls 52 each having outer walls 52 and inner walls 54 as well as curved top edges 56. FIG. 11 is an exploded view similar to FIG. 4 showing collar 50 to be fit over and supported by top edges 45. Persons of skill in the art will recognize that container assembly 30 will hold a flexible liner using a snug fit as described above for a container and collar each having a single as described above.

Thus it is seen that the objects of the invention are efficiently obtained, although changes and modifications to the invention should be readily apparent to those having ordinary skill in the art, which changes would not depart from the spirit and scope of the invention as claimed.

### PARTS LIST

10 trash can assembly

12 container

14 container wall

15 top edge

16 outer surface

17 inner surface

18 bottom surface

20 collar

22 outer collar wall

22a outer surface of outer collar wall 22

22b inner surface of outer collar wall 22

24 inner collar wall

26 curved top edge

28 channel

30 flexible liner

30a upper portion of flexible liner

40 trash can assembly (second embodiment)

42 container

44 container walls

45 top edges

50 collar

52 outer collar walls

54 inner collar walls

56 curved top edges

1. A container assembly comprising:
a container including:
a bottom surface;
a central axis extending from said bottom surface;
at least one wall extending outwardly in relation to said central axis from said bottom surface, said at least one wall having a top edge; and,
a collar including:
at least one inner wall;
at least one outer wall;
at least one curved edge joining said at least one outer wall and said at least one inner wall;
wherein said at least one inner wall extends downwardly parallel to said central axis; and,
wherein said at least one inner wall and said at least one outer wall form a channel therebetween.

2. The container assembly as recited in claim 1 wherein said at least one inner wall is a single inner wall and said at least one outer wall is a single outer wall and said at least one curved edge is a single curved edge.

3. The container assembly as recited in claim 2 wherein said single curved edge fits over each of said at least one top edge of said container.

4. The container assembly as recited in claim 3 wherein said single curved edge and said at least one top edge form a snug fit.

5. The container assembly as recited in claim 2 further comprising a flexible inner liner wherein said flexible inner liner is longer than the longest one of said at least one container wall.

6. The container assembly as recited in claim 5 wherein said flexible inner liner is draped over each of said at least one top edge.

7. The container assembly as recited in claim 6 wherein said draped flexible inner liner is held between said single curved edge and said at least one top edge in a snug fit.

8. The container assembly as recited in claim 7 wherein said single outer wall is longer than a draped portion of said flexible inner liner.

9. The container assembly as recited in claim 1 wherein said at least one container wall is a plurality of container walls, said at least one top edge is a plurality of top edges, said at least one inner wall is a plurality of inner walls, said at least one outer wall is a plurality of outer walls, and said at least one curved edge is a plurality of curved edges.

10. The container assembly as recited in claim 9 wherein each one of said plurality of curved edges fits over one of said plurality of edges of said container.

11. The container assembly as recited in claim 10 wherein each one of said plurality of curved edges and each one of said plurality of top edges forms a snug fit.

12. The container assembly as recited in claim 10 further comprising a flexible inner liner wherein said flexible inner liner is longer than the longest one of said plurality of container walls.

13. The container assembly as recited in claim 12 wherein said flexible inner liner is draped over each of said plurality of top edges.

14. The container assembly as recited in claim 13 wherein said draped flexible inner liner is held between each of said plurality of curved edges and each of said plurality of top edges in a snug fit.

15. The container assembly as recited in claim 14 wherein each of said plurality of outer walls is longer than a draped portion of said flexible inner liner.

16. A container assembly comprising:
a container including:
a bottom surface;
a central axis extending from said bottom surface;
at least one wall extending outwardly in relation to said central axis from said bottom surface, said at least one wall having a top edge;
a collar including:
at least one inner wall;
at least one outer wall;
at least one curved edge joining said at least one outer wall and said at least one inner wall;
wherein said at least one inner wall extends downwardly parallel to said central axis; and,
wherein said at least one inner wall and said at least one outer wall form a channel therebetween; and,
a flexible liner draped over each of said at least one top edge;
wherein said draped flexible inner liner is held between a bottom portion of said at least one inner wall and between said single curved edge and said at least one top edge in a snug fit.
